(19) United States
(12) Patent Application Publication
(10) Pub. No.: US 2022/0169236 A1
(43) Pub. Date: Jun. 2, 2022

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventors: Sang Jae Han, Hwaseong-si (KR); Jae Min Kwon, Incheon (KR); Hyunwook Kim, Seoul (KR)

(73) Assignees: HYUNDAI MOTOR COMPANY, Seoul (KR); KIA CORPORATION, Seoul (KR)

(21) Appl. No.: 17/525,599

(22) Filed: Nov. 12, 2021

(30) Foreign Application Priority Data
Nov. 30, 2020 (KR) 10-2020-0164129

(51) Int. Cl. B60W 20/13; B60L 58/10; B60L 53/20

(52) U.S. Cl. CPC B60W 20/13; B60L 53/20; B60L 58/10

(57) ABSTRACT

A vehicle includes: a first battery; a first electrical load; a second battery; a cut-off switch provided between the first battery and the first electrical load; a power transmission device provided between the first electrical load and the second battery; and a power management device configured to control the power transmission device and the cut-off switch. The power transmission device includes first and second power switches connected back-to-back to each other and a DC-DC converter connected in parallel with the first and second power switches. Based on the vehicle being turned off, the power management device may be configured to turn off the cut-off switch and turn on at least one of the first and second power switches.

### CROSS-REFERENCE TO RELATED APPLICATION(S)

This application is based on and claims priority under 35 U.S.C. § 119 to Korean Patent Application No. 10-2020-0164129, filed on Nov. 30, 2020, the disclosure of which is incorporated herein by reference.

### BACKGROUND

### 1. Field

The present disclosure relates to a vehicle and a method of controlling the vehicle and, more particularly, relates to a vehicle capable of preventing a deterioration of a battery and a method of controlling the vehicle.

### 2. Description of Related Art

A vehicle is a moving means or transportation means for driving on a road and railway using fossil fuels and/or electricity as a power source. For example, the vehicle may be driven using power generated from an engine.

The vehicle includes various electrical devices to protect a driver and provide the driver with convenience and entertainment, and the electrical devices consume power. The vehicle also includes a battery to supply the power to the electrical devices and a generator capable of supplying the power to the electrical devices and charging the battery.

Due to a rapid increase in power consumption of the electrical devices in the vehicle, the power consumption of the electrical devices is increasing not only when the vehicle is driving but also when the vehicle is parked.

Due to the increase in power consumption during parking of the vehicle, it is required to increase a capacity of the battery. However, even if the capacity of one battery is simply increased, the vehicle cannot be started due to discharge of the battery, or a life of the battery may be shortened.

In order to solve this problem, a vehicle power system having different types of batteries suitable for current consumption characteristics has been developed. For example, a vehicle power system including a lead-acid battery that provides the power for starting the vehicle and a lithium-ion battery that provides the power to a convenient load is being developed.

Such a dual power system essentially requires a converter to redistribute the power among the batteries.

### SUMMARY

An aspect of the present disclosure is to provide a vehicle with a vehicle power converter capable of preventing power interruption or overcurrent during power redistribution.

Additional aspects of the present disclosure are set forth, in part, in the description below and should be apparent, in part, from the description, or additional aspects of the disclosure may be learned by practice of the present disclosure.

According to an aspect of the present disclosure, a vehicle includes: a first battery; a first electrical load; a second battery; a cut-off switch provided between the first battery and the first electrical load; a power transmission device provided between the first electrical load and the second battery; and a power management device configured to control the power transmission device and the cut-off switch. The power transmission device includes first and second power switches connected back-to-back to each other and a DC-DC converter connected in parallel with the first and second power switches. Based on the vehicle being turned off, the power management device may be configured to turn off the cut-off switch and turn on at least one of the first and second power switches.

Based on the vehicle being turned on, the power management device may be configured to turn on the cut-off switch, to turn off the first and second power switches, and to operate the DC-DC converter.

Based on the vehicle being turned off, the power management device may be configured to turn off the DC-DC converter.

Based on a charging state of the first battery and a charging state of the second battery, the power management device may be configured to turn on the at least one of the first and second power switches.

Based on an output current of the first battery being less than an output current of the second battery, the power management device may be configured to turn on the at least one of the first and second power switches.

Based on a state of charge (SOC) of the second battery being greater than a reference value, the power management device may be configured to turn on the at least one of the first and second power switches.

The first power switch may include a first freewheeling diode that allows a current from the second battery to the first electrical load and blocks a current from the first battery to the second battery. Based on a charging state of the first battery and a charging state of the second battery, the power management device may be configured to turn on the first power switch among the first and second power switches.

The power management device may be configured to turn off the cut-off switch after turning on the at least one of the first and second power switches.

The power management device may be configured to turn on both the first and second power switches after turning off the cut-off switch.

After turning on both the first and second power switches, the power management device may be configured to turn on the cut-off switch and turn off both the first and second power switches based on a charging state of the first battery and a charging state of the second battery.

After turning on both the first and second power switches, the power management device may be configured to turn on the cut-off switch and turn off both the first and second power switches based on an output current of the first battery being greater than an output current of the second battery or a state of charge (SOC) of the second battery being less than a reference value.

Another aspect of the present disclosure provides a method of controlling a vehicle, the vehicle including a first battery, a first electrical load, and a second battery. The method includes, based on the vehicle being turned on, turning on, by a power management device, a cut-off switch provided between the first battery and the first electrical load and operating a DC-DC converter provided between the first electrical load and the second battery. The method also includes, based on the vehicle being turned off, turning off, by the power management device, the DC-DC converter. The method also includes, based on the vehicle being turned off, turning on, by the power management device, at least one of first and second power switches provided between the first electrical load and the second battery and connected back-to-back to each other.

The turning on the at least one of the first and second power switches may include, based on a charging state of the first battery and a charging state of the second battery, turning on the at least one of the first and second power switches.

The turning on the at least one of the first and second power switches may include, based on an output current of the first battery being less than an output current of the second battery, turning on the at least one of the first and second power switches.

The turning on the at least one of the first and second power switches may include, based on a state of charge (SOC) of the second battery being greater than a reference value, turning on the at least one of the first and second power switches.

The turning on the at least one of the first and second power switches may include, based on a charging state of the first battery and a charging state of the second battery, turning on the first power switch including a first freewheeling diode that allows a current from the second battery to the first electrical load and blocks a current from the first battery to the second battery.

The method may further include turning off, by the power management device, the cut-off switch after turning on the at least one of the first and second power switches.

The method may further include turning on, by the power management device, both the first and second power switches after turning off the cut-off switch.

The method may further include, after turning on both the first and second power switches, turning on, by the power management device, the cut-off switch and turn off both the first and second power switches based on a charging state of the first battery and a charging state of the second battery.

The method may further include, after turning on both the first and second power switches, turning on, by the power management device, the cut-off switch and turning off both the first and second power switches based on an output current of the first battery being greater than an output current of the second battery, a state of charge (SOC) of the first battery being less than a first reference value, or the SOC of the second battery being less than a second reference value.

### BRIEF DESCRIPTION OF THE DRAWINGS

These and/or other aspects of the present disclosure should become apparent and more readily appreciated from the following description of the embodiments, taken in conjunction with the accompanying drawings of which:

FIG. 1 is a view illustrating a configuration of a vehicle and an information providing system including the vehicle according to an embodiment;

FIG. 1 is a view illustrating power management of a vehicle according to an embodiment;

FIG. 2 is a view illustrating a power transmission device according to an embodiment;

FIG. 3 is a view illustrating a plurality of operation modes of a power transmission device according to an embodiment;

FIG. 4 is a view illustrating an operation of a power transmission device in a first mode according to an embodiment;

FIG. 5 is a view illustrating an operation of a power transmission device in a second mode according to an embodiment;

FIG. 6 is a view illustrating an operation of a power transmission device in a third mode according to an embodiment;

FIG. 7 is a view illustrating an operation of a power transmission device in a fourth mode according to an embodiment; and

FIG. 8 is a view illustrating an operation of a power management device according to an embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein should be apparent to those of ordinary skill in the art. The sequence of processing operations described is an example. However, the sequence of the operations is not limited to that set forth herein and may be changed as known in the art, with the exception of operations necessarily occurring in a particular order. In addition, respective descriptions of well-known functions and constructions may be omitted for increased clarity and conciseness.

Additionally, embodiments are now described more fully hereinafter with reference to the accompanying drawings. The embodiments may, however, be embodied in many different forms and should not be construed as being limited to the embodiments set forth herein. These embodiments are provided so that the present disclosure can be thorough and complete and fully convey the embodiments to those of ordinary skill in the art. Like numerals denote like elements throughout the present disclosure.

It should be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It should be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

Reference is made in detail to the embodiments of the present disclosure, examples of which are illustrated in the accompanying drawings.

The expression, “at least one of a, b, and c,” should be understood as including only a, only b, only c, both a and b, both a and c, both b and c, or all of a, b, and c. When a component, device, element, or the like of the present disclosure is described as having a purpose or performing an operation, function, or the like, the component, device, or element should be considered herein as being “configured to” meet that purpose or to perform that operation or function.

Hereinafter, an operation principle and embodiments of the present disclosure are described with reference to accompanying drawings.

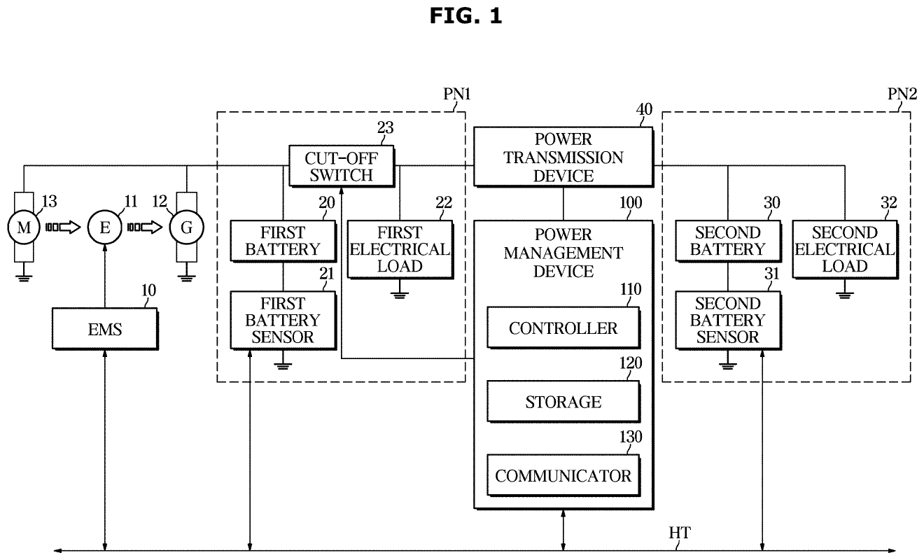

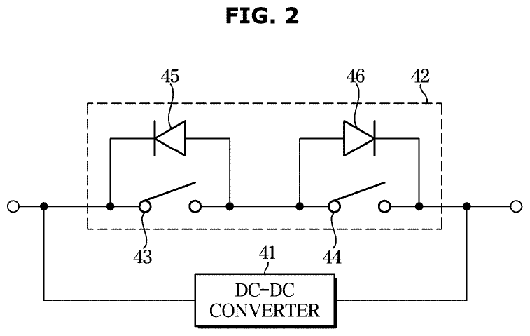

FIG. 1 is a view illustrating power management of a vehicle according to an embodiment. FIG. 2 is a view illustrating a power transmission device according to an embodiment.

A vehicle 1 may include a body forming an external appearance of the vehicle 1 and accommodating a driver and/or cargo, a chassis having components of the vehicle 1 other than the body, and electrical devices protecting the driver and providing convenience to the driver.

Referring to FIG. 1, the vehicle 1 may include an engine management system (EMS) 10, a starter motor 13, an engine 11, a generator 12, a first battery 20, a first battery sensor 21, a cut-off switch 23, a first electrical load 22, a power transmission device 40, a second battery 30, a second battery sensor 31, a second electrical load 32, and a power management device 100. The electrical devices may communicate with each other through a vehicle communication network NT. For example, the electrical devices may transmit and receive data through Ethernet, Media Oriented Systems Transport (MOST), Flexray, Controller Area Network (CAN), Local Interconnect Network (LIN), and the like.

The engine 11 may generate the power using explosive combustion of fuel, and the power of the engine 11 may be transmitted to a wheel. Part of a rotational force generated by the engine 11 may be supplied to the generator 12 and the generator 12 may generate the power from the power of the engine 11. A part of the power generated by the generator 12 may be supplied to the electrical devices of the vehicle 1 and the other part may be stored in the batteries 20 and 30 of the vehicle 1.

The generator 12 is mechanically connected to a rotational shaft of the engine 11 and may generate electrical energy, i.e., the power from the rotational force of the engine 11. In addition, the generator 12 is electrically connected to the batteries 20 and 30 and the electrical loads 22 and 32 and may provide the generated power to the batteries 20 and 30 and the electrical loads 22 and 32.

In addition, the generator 12 is connected directly to the power management device 100 or through the vehicle communication network NT and may generate the electrical energy, i.e., the power in response to a power generation control signal of the power management device 100.

The starter motor 13 may provide power to the engine 11 to start the engine 11 while the engine 11 is stopped. The starter motor 13 may receive the power from the first battery 20.

Since the starter motor 13 consumes a large amount of power to start the engine 11, a state of charge (SOC) of the first battery 20 maintains the SOC of a predetermined level or more (for example, the SOC of about 30% or more) for an operation of the starter motor 13.

The engine management system 10 may control the operation of the engine 11 in response to the driver's acceleration command through an accelerator pedal and may manage the engine 11. For example, the engine management system 10 may perform engine torque control, fuel consumption control, engine failure diagnosis, and/or generator control. The engine management system 10 may control the generator 12 that produces the power from the rotation of the engine 11.

The first battery 20 may be electrically connected to the generator 12, the starter motor 13, and electrical loads 22 and 32. The first battery 20 may store the electrical energy produced by the generator 12 and provide the power to the first electrical load 22.

When the vehicle 1 drives, the generator 12 may convert a rotational energy of the engine 11 into electrical energy, and the first battery 20 may receive and store the electrical energy from the generator 12. When the power consumed by the electrical loads 22 and 32 while the vehicle 1 is driving is greater than the power produced by the generator 12, the first battery 20 may supply the power to the electrical loads 22 and 32. In addition, during the parking in which the engine 11 is stopped, the first battery 20 may supply the power to the electrical loads 22 and 32.

The first battery sensor 21 may detect an output (output voltage, output current, etc.) of the first battery 20. The first battery sensor 21 may generate battery data based on the output voltage of the first battery 20, the output current of the first battery 20, and a temperature of the first battery 20.

For example, the first battery sensor 21 may determine the SOC of the battery 20 based on the output voltage of the first battery 20, the output current of the first battery 20, and the temperature of the first battery 20. The SOC of the first battery 20 may represent a degree of storing the electrical energy in the first battery 20. The SOC of the first battery 20 generally has a value of 0 to 100% and may represent a degree to which the first battery 20 is charged between a fully discharged state (0%) and a full SOC (100%). The SOC of the first battery 20 may be calculated based on an open circuit voltage (OCV) of the first battery 20 and an input/output current of the first battery 20.

In addition, the first battery sensor 21 may determine an internal resistance of the first battery 20 based on the output voltage of the first battery 20 and the output current of the first battery 20 when the engine 11 is started. The first battery sensor 21 may determine a state of health (SOH) of the first battery 20 based on the internal resistance of the first battery 20 and a charging/discharging time of the battery 20. The SOH of the first battery 20 generally has a value of 0 to 100% and may represent a degree to which the first battery 20 is deteriorated between a full SOH (0%) and a fully latest state (100%).

As such, the first battery sensor 21 may provide first battery data including the SOC of the first battery 20 and the SOH of the first battery 20 to the power management device 100.

The first electrical load 22 may be electrically connected to the first battery 20 and the generator 12. The first electrical load 22 may operate using the power supplied from the first battery 20 and/or the generator 12.

The first electrical load 22 may be a device for driving/braking/steering of the vehicle 1 or providing convenience to the driver of the vehicle 1. For example, the first electrical load 22 may include the EMS 10, a transmission control unit (TCU), an electronic brake control module (EBCM), motor-driven power steering (MDPS), a body control module (BCM), an audio device, an air conditioner (heating/ventilation/air conditioning, HVAC), a navigation device, a power seat, a seat heater, and a headlight.

The cut-off switch 23 may be disposed between the generator 12/the first battery 20 and the first electrical load 22. Particularly, one end of the cut-off switch 23 may be connected to the generator 12 and the first battery 20, and the other end of the cut-off switch 23 may be connected to the first electrical load 22.

The cut-off switch 23 may allow or block supply of the power from the generator 12 and/or the first battery 20 to the first electrical load 22 and/or the second battery 30 and/or the second electrical load 32 depending on a control signal of the power management device 100. For example, while the vehicle 1 is driving, the cut-off switch 23 may be turned on to allow or block supply of the power from the generator 12 and/or the first battery 20 to the first electrical load 22 and/or the second battery 30 and/or the second electrical load 32. In addition, while the vehicle 1 is driving, the cut-off switch 23 may be turned off to allow or block supply of the power from the generator 12 and/or the first battery 20 to the first electrical load 22 and/or the second battery 30 and/or the second electrical load 32.

The cut-off switch 23 may be a mechanical or electrical device such as a relay. In addition, the cut-off switch 23 may be semiconductor devices such as a metal-oxide-semiconductor field-effect transistor (MOSFET) or a bipolar junction transistor (BJT) or an insulated gate bipolar transistor (IGBT).

The second battery 30 may be electrically connected to the power transmission device 40 and the electrical loads 22 and 32. The second battery 30 may store the electrical energy provided from the first battery 20 and/or the generator 12 through the power transmission device 40 and provide the electrical energy to the second electrical load 32. For example, the power transmission device 40 may transmit the electrical energy of the first battery 20 to the second battery 30, and the second battery 30 may receive and store the electrical energy from the power transmission device 40. When the power consumed by the second electrical load 32 is greater than the power transmitted by the power transmission device 40, the second battery 30 may supply the power to the second electrical load 32.

The second battery sensor 31 may detect the output (output voltage, output current, etc.) of the second battery 30. The second battery sensor 31 may generate the battery data based on the output voltage of the second battery 30, the output current of the second battery 30, and a temperature of the second battery 30. The second battery sensor 31 may provide second battery data including the SOC of the second battery 30 and the SOH of the second battery 30 to the power management device 100.

The second electrical load 32 may be electrically connected to the second battery 30 and the power transmission device 40. The second electrical load 32 may operate using the power supplied from the second battery 30 and/or the power transmission device 40.

The second electrical load 32 may be a device that provides convenience to the driver of the vehicle 1 by consuming the power supplied from the second battery 30 or the power transmission device 40. The second electrical load 32 may include, for example, the audio device, the air conditioner (HVAC), the navigation device, the power seat, the seat heater, the headlight, and the like.

The power transmission device 40 may be electrically connected to the generator 12, the first battery 20, the first electrical load 22, the second battery 30, and the second electrical load 32. In particular, the power transmission device 40 may be provided between a first power network PN1, including the generator 12, the first battery 20, and the first electrical load 22, and a second power network PN2, including the second battery 30 and the second electrical load 32.

The power transmission device 40 may transmit the power from the first battery 20 to the second battery 30 and/or the second electrical load 32 or may transmit the electrical energy from the second battery 30 to the first battery 20 and/or the first electrical load 22.

The power transmission device 40 may include a DC-DC converter 41 and a switching circuit 42.

The DC-DC converter 41 may transfer the electrical energy between the first battery 20 and the second battery 30.

When the output voltage of the first battery 20 and the output voltage of the second battery 30 are different (for example, the first battery 20 outputs a high voltage of 45V to 400V, and the second battery 30 outputs a low voltage of 12V), the DC-DC converter 41 may convert the high voltage of the first battery 20 into the low voltage of the second battery 30 and output it to the second battery 30, or the DC-DC converter 41 may convert the low voltage of the second battery 30 into the high voltage of the first battery 30 and output it to the first battery 20.

When the output voltage of the first battery 20 and the output voltage of the second battery 30 are approximately the same (for example, when both the first battery 20 and the second battery 30 output approximately 12V voltage), the DC-DC converter 41 may convert the output voltage of the first battery 20 into a target voltage (e.g., 14.5V) and output it to the second battery 30, or may convert the output voltage of the second battery 30 into the target voltage (e.g., 14.5V) and output it to the first battery 20.

The switching circuit 42 may include a pair of power switches 43 and 44. Particularly, the switching circuit 42 may include a first power switch 43 and a second power switch 44 connected in series with each other. The first power switch 43 and the second power switch 44 may be connected back-to-back, for example, as illustrated in FIG. 2.

The first power switch 43 may include a first freewheeling diode 45 that allows a current from the second power network PN2 to the first power network PN1 and blocks a current from the first power network PN1 to the second power network PN2. In addition, the second power switch 44 may include a second freewheeling diode 46 that allows the current from the first power network PN1 to the second power network PN2 and blocks the current from the second power network PN2 to the first power network PN1.

The first power switch 43 may be connected to the first power network PN1, and the second power switch 44 may be connected to the second power network PN2.

In FIG. 2, the first power switch 43 and the second power switch 44 may be connected in a common-drain type but are not limited thereto. For example, the first power switch 43 and the second power switch 44 may be connected in a common-source type.

In addition, in FIG. 2, the switching circuit 42 includes the pair of power switches 43 and 44 connected in the common-drain type but is not limited thereto. For example, the switching circuit 42 may include the pair of power switches 43 and 44 back-to-back connected by the common-drain type and the pair of power switches 43 and 44 back-to-back connected by the common-source type.

Each of the first power switch 43 and the second power switch 44 may be the mechanical or electrical device such as the relay. In addition, the first power switch 43 and the second power switch 44 may be semiconductor devices such as the MOSFET or the BJT or the IGBT, respectively.

The power management device 100 may monitor a power state of the vehicle 1 based on the first battery data and the second battery data and may control power generation by the generator and power transmission by the power transmission device 40 based on the power state of the vehicle 1. For example, the power management device 100 may control the generator 12 so that the SOC of the first battery 20 is maintained above the predetermined level, and the power management device 100 may control the power management device 100 so that the SOC of the second battery 30 is maintained above the predetermined level.

For example, while the vehicle 1 is turned on, the power management device 100 may receive the first battery data from the first battery sensor 21 through the vehicle communication network NT and may transmit the power generation control signal for controlling the generated power of the generator 12 to the generator 12 through the vehicle communication network NT. The generator 12 may adjust the generated power in response to the power generation control signal. In addition, the power management device 100 may receive the second battery data from the second battery sensor 31 through the vehicle communication network NT. The power management device 100 may transmit a transmission control signal for controlling the power transmission of the power transmission device 40 to the power transmission device 40 through the vehicle communication network NT (or directly). The power transmission device 40 may control the power transmission in response to the transmission control signal.

As another example, while the vehicle 1 is turned off, the power management device 100 may receive the first battery data and the second battery data through the vehicle communication network NT (or directly). The power management device 100 may transmit the transmission control signal for controlling the power transmission of the power transmission device 40 and transmit a cut-off control signal for controlling the power cut of the cut-off switch 23 to the power transmission device 40 and the cut-off switch 23. The power transmission device 40 may control the power transmission between the first power network PN1 and the second power network PN2 in response to the transmission control signal. The cut-off switch 23 may block or allow the power supply by the first battery 20 in response to the cut-off control signal.

The power management device 100 may include a communicator 130, a storage 120, and a controller 110.

The communicator 130 may include a CAN transceiver that receives communication signals from other electric devices of the vehicle 1 through the vehicle communication network NT and transmits the communication signals to other electric devices of the vehicle 1. The communicator 130 may also include a communication controller that controls operations of the CAN transceiver.

The CAN transceiver may receive the first battery data and the second battery data from the first battery sensor 21 and the second battery sensor 31 through the vehicle communication network NT and may provide the first battery data and the second battery data to the controller 110. In addition, the CAN transceiver may receive the power generation control signal from the controller 110 and transmit the power generation control signal to the generator 12 through the vehicle communication network NT. The CAN transceiver may also receive the transmission control signal from the controller 110 and transmit the transmission control signal to the power transmission device 40 through the vehicle communication network NT. The CAN transceiver may receive the cut-off control signal from the controller 110 and transmit the cut-off control signal to the cut-off switch 23 through the vehicle communication network NT.

As such, the power management device 100 may communicate with the electrical devices such as the generator 12, the first battery sensor 21, the second battery sensor 31, the power transmission device 40, and the cut-off switch 23 through the communicator 130.

The storage 120 may include a storage medium for storing control data for controlling the power management device 100. The storage 120 may also include a storage controller for controlling storage/deletion/loading of data stored in the storage medium.

The storage medium may include a Solid State Drive (SSD) and a Hard Disc Drive (HDD), and the like, and may store various data for managing the SOC of the first battery 20.

The storage controller may store data in the storage medium in response to a storage signal from the controller 110 and output data stored in the storage medium to the controller 110 in response to a loading signal from the controller 110.

The controller 110 may include a memory for storing control programs and/or control data for controlling the power management device 100. The controller 110 may also include a processor for generating control signals according to control programs and control data stored in the memory.

The memory may provide a program and/or data to the processor in accordance with a memory control signal of the processor.

The memory may temporarily store communication data received through the communicator 130 and/or stored data stored in the storage 120.

The memory may include a volatile memory, such as Static Random Access Memory (S-RAM) and Dynamic Random Access Memory (D-RAM). In addition, the memory may include a non-volatile memory, such as Read Only Memory (ROM), Erasable Programmable ROM (EPROM), and Electrically Erasable Programmable ROM (EEPROM).

The processor may process data according to a program provided from the memory and generate the control signal according to the processing result. For example, the processor may process communication data received through the communicator 130 and/or storage data stored in the storage 120 and output the power generation control signal for controlling an power generation operation of the generator 12.

The processor may include various logic circuits and arithmetic circuits. The processor and the memory may be implemented as a single chip or may be implemented as separate chips.

The controller 110 may control the generator 12 based on the first battery data of the first battery 20 and control the power transmission device 40 based on the second battery data of the second battery 30 while the vehicle 1 is turned on. In addition, the controller 110 may control the cut-off switch 23 and the power transmission device 40 based on the first battery data and the second battery data while the vehicle 1 is turned off.

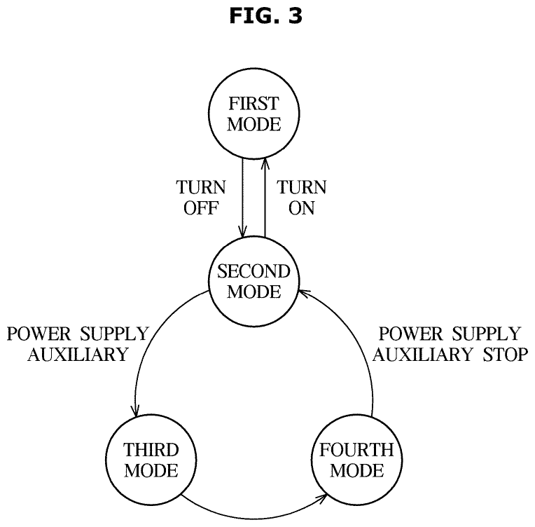

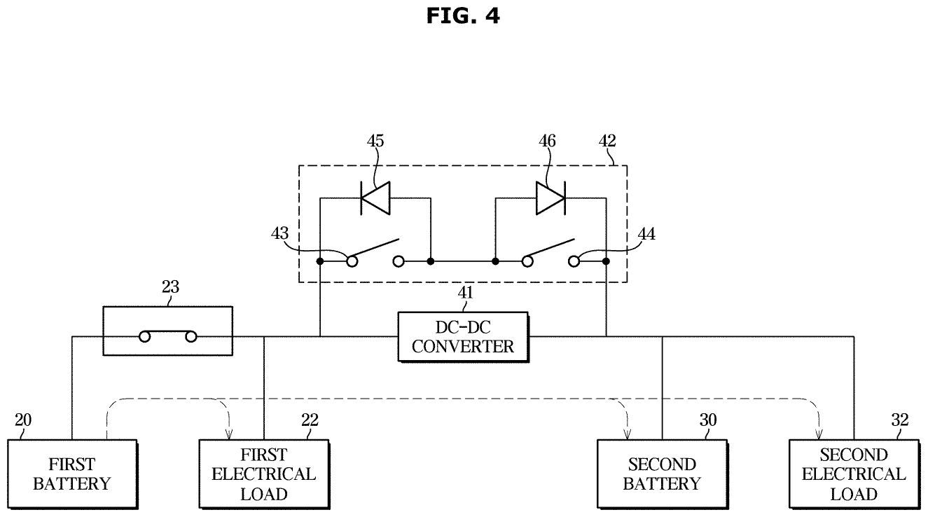

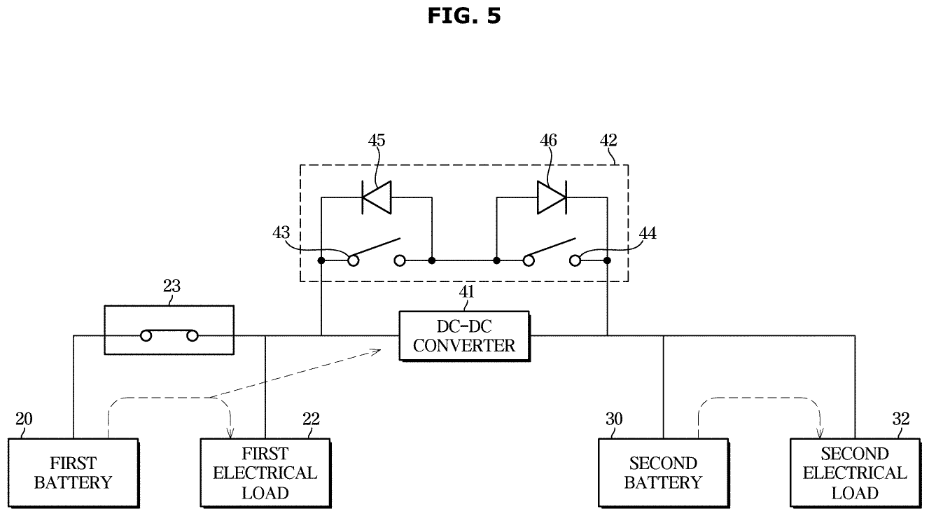

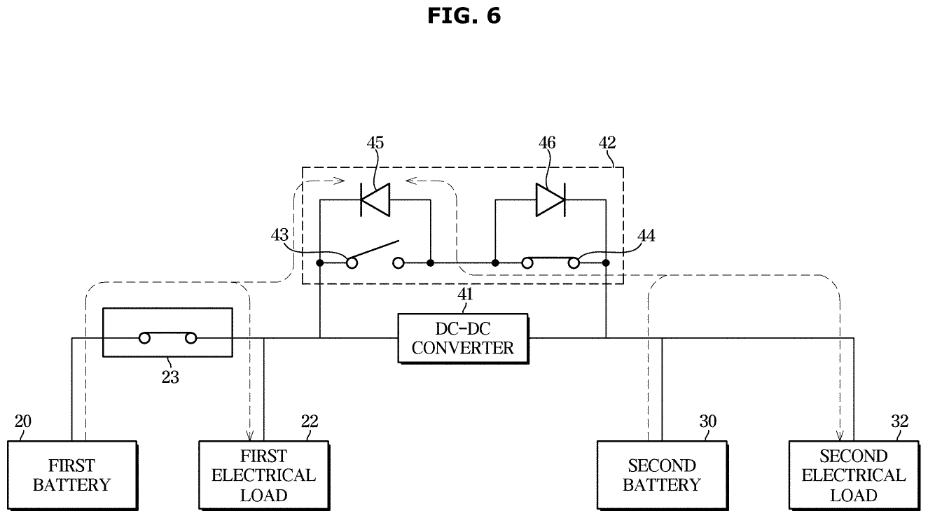

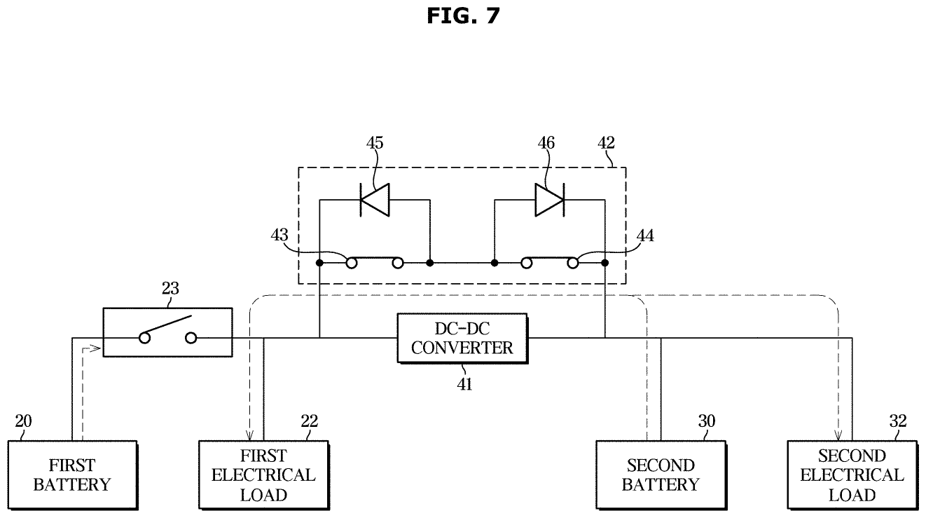

FIG. 3 is a view illustrating a plurality of operation modes of a power transmission device according to an embodiment. FIG. 4 is a view illustrating an operation of a power transmission device in a first mode according to an embodiment. FIG. 5 is a view illustrating an operation of a power transmission device in a second mode according to an embodiment. FIG. 6 is a view illustrating an operation of a power transmission device in a third mode according to an embodiment. FIG. 7 is a view illustrating an operation of a power transmission device in a fourth mode according to an embodiment.

Together with FIGS. 3, 4, 5, 6, and 7, the operation of the power transmission device 40 in a plurality of modes is described.

As illustrated in FIG. 3, the power management device 100 may control the power transmission device 40 and the cut-off switch 23 to operate in the plurality of modes according to a driving state of the vehicle 1 and charging states of the batteries 20 and 30.

While the vehicle 1 is turned on, the power management device 100 may control the power transmission device 40 and the cut-off switch 23 to operate in a first mode. While the vehicle 1 is turned on, the generator 12 of the first power network PN1 may generate the power. Accordingly, the power management device 100 may control the power transmission device 40 to transmit the power generated by the generator 12 to the second battery 30 and the second electrical load 32.

In the first mode, the power management device 100 may turn off the switching circuit 42 and activate the DC-DC converter 41. In addition, the power management device 100 may turn on the cut-off switch 23.

In the first mode, the power transmission device 40 may transmit the power of the first power network PN1 to the second power network PN2. By such a configuration, as illustrated in FIG. 4, the first electrical load 22 may operate using the power produced by the generator 12, and the first battery 20 may be charged using the power produced by the generator 12. In addition, the second electrical load 32 may operate using the power converted by the DC-DC converter 41, and the second battery 30 may be charged using the power converted by the DC-DC converter 41.

When the vehicle 1 is turned off, the power management device 100 may first control the power transmission device 40 and the cut-off switch 23 to switch to a second mode. When the vehicle 1 is turned off, the power generation by the generator 12 may be stopped. Therefore, in order to minimize power loss due to the power transmission between the first power network PN1 and the second power network PN2, the power management device 100 may control the power transmission device 40 to block the power transmission between the first power network PN1 and the second power network PN2.

In the second mode, the power management device 100 may turn off the switching circuit 42 and turn off the DC-DC converter 41 as illustrated in FIG. 5. In addition, the power management device 100 may maintain the cut-off switch 23 in an on state.

In the first mode, the power transmission device 40 may isolate the first power network PN1 and the second power network PN2. By such a configuration, as illustrated in FIG. 4, the first electrical load 22 may operate using the power stored in the first battery 20, and the first battery 20 may be discharged. In addition, the second electrical load 32 may operate using the power stored in the second battery 30, and the second battery 30 may be discharged.

In the second mode, the power management device 100 may identify whether the second battery 30 can provide the power to the first electrical load 22 based on the charging state of the first battery 20 and the charging state of the second battery 30. For example, the power management device 100 may identify whether the output current of the first battery 20 is less than the output current of the second battery 3 and may identify whether the SOC of the second battery 30 is greater than a second reference value. Also, according to the embodiment, the power management device 100 may identify whether the SOC of the first battery 20 is greater than a first reference value.

The power management device 100 may identify whether the second battery 30 can provide power to the first electrical load 22 based on the temperature of the second battery 30. For example, the power management device 100 may identify whether the temperature of the second battery 30 is within a predetermined temperature range (e.g., between 10 degrees Celsius and 50 degrees Celsius).

In addition, when the second electrical load 32 is operated while the vehicle 1 is turned off, the power management device 100 may identify whether the SOC of the second battery 30 is greater than a reference SOC capable of operating the second electrical load 32 for a predetermined time. For example, when a surrounding surveillance camera is operating, the power management device 100 may identify whether the SOC of the second battery 30 is greater than the reference SOC capable of operating the surrounding surveillance camera for 10 hours or longer. When performing an online update (Over the Air, OTA), the power management device 100 may identify whether the SOC of the second battery 30 is greater than the reference SOC for completing an online update.

When the output current of the first battery 20 is less than the output current of the second battery 3 and the SOC of the second battery 20 is greater than the second reference value, the power management device 100 may control the power transmission device 40 and the cut-off switch 23 to switch from the second mode to a fourth mode through a third mode. According to the embodiment, when the output current of the first battery 20 is less than the output current of the second battery 3 and the SOC of the first battery 20 is greater than the first reference value and the SOC of the second battery 30 is greater than the second reference value, the power management device 100 may control the power transmission device 40 and the cut-off switch 23 to switch from the second mode to the fourth mode through the third mode.

When the temperature of the second battery 30 is within a predetermined temperature range, the power management device 100 may control the power transmission device 40 and the cut-off switch 23 to switch from the second mode to the fourth mode through the third mode. On the other hand, the power management device 100 may control the power transmission device 40 and the cut-off switch 23 to maintain the second mode when the temperature of the second battery 30 is out of the predetermined temperature range.

The first battery 20 may provide the power for starting the engine 11 to the starter motor 13. For stable start-up, the first battery 20 may require an SOC of a certain level or higher. Accordingly, while the vehicle 1 is turned off, the power management device 100 may control the power transmission device 40 and the cut-off switch 23 to supply the power to the electrical loads 20 and 30 in the vehicle 1 using the second battery 30. On the other hand, when the temperature of the second battery 30 is too low or too high, a discharge performance of the second battery 30 may be lowered. Accordingly, when the temperature of the second battery 30 is out of the predetermined temperature range, the power management device 100 may control the power transmission device 40 and the cut-off switch 23 to supply the power to the first electrical load 20 through the first battery 20.

In the fourth mode in which the second battery 30 assists the power supply of the first battery 20, the power management device 100 may turn off the cut-off switch 23 to block the power supply by the first battery 20 and may turn on the switching circuit 42 of the power transmission device 40 so that the second battery 30 supplies the power to the first electrical load 22.

By such a configuration, as illustrated in FIG. 7, discharging of the first battery 20 may be stopped, and the first electrical load 22 and the second electrical load 32 may operate using the power of the second battery 30.

However, at this time, when the second mode is directly transferred to the fourth mode, the power supply to the first electrical load 22 may be temporarily cut off according to a turn-off time of the cut-off switch 23 and a turn-on time of the switching circuit 42. For example, when the switching circuit 42 is turned on after the cut-off switch 23 is first turned off, the power may not be supplied to the first electrical load 22 between the turn-off time of the cut-off switch 23 and the turn-on time of the switching circuit 42. As a result, the first electrical load 22 may be reset.

To prevent this, the power management device 100 may switch from the second mode to the fourth mode through the third mode.

In the third mode, the power management device 100 may maintain the cut-off switch 23 in the on state. In addition, the power management device 100 may control the power transmission device 40 to cut off the power supply from the first power network PN1 to the second power network PN2 and to allow the power supply from the second power network PN2 to the first power network PN1. For example, the power management device 100 may allow the current from the second power network PN2 to the first power network PN1 and block the current from the first power network PN1 to the second power network PN2. The first power switch 43 including the first freewheeling diode 45 may be maintained in an off state and may be turned on the second power switch 44.

Therefore, as illustrated in FIG. 6, in the third mode, the first battery 20 may still supply the power to the first electrical load 22 and may supply the power from the second battery 30 to the first electrical load 22 by the power transmission device 40.

Thereafter, the power management device 100 may turn off the cut-off switch 23 while maintaining the off state of the first power switch 43 and the on state of the second power switch 44 in order to switch from the third mode to the fourth mode. In this case, even if the cut-off switch 23 is turned off, the power may be supplied from the second battery 30 to the first electrical load 22 through the first freewheeling diode 45. Thereafter, the power management device 100 may turn on the first power switch 43 so that the power transmission device 40 can operate as the fourth mode.

In other words, in order to switch from the second mode to the fourth mode, the power management device 100 may turn on the second power switch 44 of the power transmission device 40, then turn off the cut-off switch 23, and then turn on the first power switch 43 of the power transmission device 40. By such a configuration, the first electrical load 22 may be switched from the second mode to the fourth mode without a risk of being reset.

In the fourth mode, as illustrated in FIG. 7, the second battery 30 may supply the power to the first electrical load 22 as well as the second electrical load 32.

In the fourth mode, the power management device 100 may identify whether the second battery 30 can provide the power to the first electrical load 22 based on the charging state of the first battery 20 and the charging state of the second battery 30.

When the output current of the first battery 20 is greater than the output current of the second battery 3 or the SOC of the second battery 30 is less than the second reference value, the power management device 100 may control the power transmission device 40 and the cut-off switch 23 to switch from the fourth mode to the second mode. According to the embodiment, when the SOC of the first battery 20 is less than the first reference value, the power management device 100 may control the power transmission device 40 and the cut-off switch 23 to switch from the fourth mode to the second mode. Particularly, the power management device 100 may turn on the cut-off switch 23 and turn off the switching circuit 42.

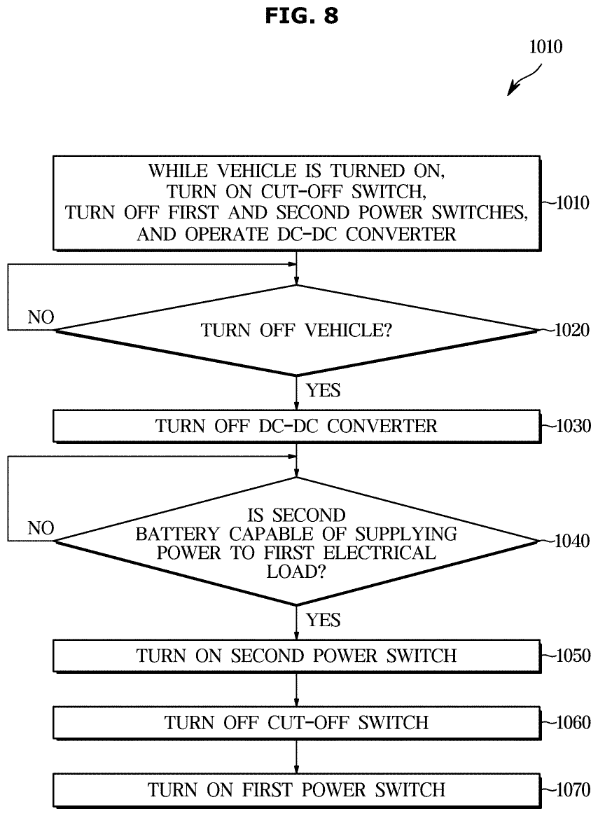

FIG. 8 is a view illustrating an operation of a power management device according to an embodiment.

Together with FIG. 8 and FIG. 1, the vehicle 1 includes the first battery 20, the first electrical load 22, the second battery 30, the cut-off switch 23 provided between the first battery 20 and the first electrical load 22, and the power transmission device 40 provided between the first electrical load 22 and the second battery 30. The power transmission device 40 includes the first and second power switches 43 and 44 connected back-to-back with the DC-DC converter 41. An operation 1000 of the power management device 100 for controlling the power transmission device 40 is described below.

While the vehicle 1 is turned on, the power management device 100 may turn on the cut-off switch 23, turn off the first and second power switches 43 and 44, and operate the DC-DC converter 41 (1010).

While the vehicle 1 is turned on, the power management device 100 may operate in the first mode. In the first mode, the power management device 100 may turn off the switching circuit 42 and activate the DC-DC converter 41. In addition, the power management device 100 may turn on the cut-off switch 23. By such a configuration, the first electrical load 22 may operate using the power produced by the generator 12, and the first battery 20 may be charged using the power produced by the generator 12. In addition, the second battery 30 may be charged using the power converted by the DC-DC converter 41.

The power management device 100 may identify whether the vehicle 1 is turned off (1020).

The power management device 100 may communicate with the engine management system 10 that controls the engine 11 of the vehicle 1 and may identify whether the vehicle 1 is turned off based on the communication signal of the engine management system 10.

When the vehicle 1 is not turned off (NO in 1020), the power management device 100 may maintain the first mode.

When the vehicle 1 is turned off (YES in 1020), the power management device 100 may turn off the DC-DC converter 41 (1030).

When the vehicle 1 is turned off, the power management device 100 is first switched to the second mode. In the second mode, the power management device 100 may turn off the switching circuit 42 and turn off the DC-DC converter 41. In addition, the power management device 100 may maintain the cut-off switch 23 in the on state. By such a configuration, the first battery 20 and the second battery 30 may be discharged.

The power management device 100 may identify whether the second battery 30 can supply the power to the first electrical load 22 (1040).

The power management device 100 may identify whether the output current of the first battery 20 is less than the output current of the second battery 3 and may identify whether the SOC of the second battery 30 is greater than the second reference value. Depending on the embodiment, the power management device 100 may identify whether the SOC of the first battery 20 is greater than the first reference value.

Also, the power management device 100 may identify whether the temperature of the second battery 30 is within the predetermined temperature range.

When the second battery 30 cannot supply the power to the first electrical load 22 (NO in 1040), the power management device 100 may maintain the second mode.

When the output current of the first battery 20 is greater than the output current of the second battery 3 or the SOC of the second battery 30 is less than the second reference value, the power management device 100 may maintain the second mode. According to the embodiment, when the SOC of the first battery 20 is less than the first reference value, the power management device 100 may maintain the second mode.

In addition, the power management device 100 may maintain the second mode when the temperature of the second battery 30 is out of the predetermined temperature range.

When the second battery 30 can supply the power to the first electrical load 22 (YES in 1040), the power management device 100 may turn on the second power switch 44 (1050).

When the second battery 30 can supply the power to the first electrical load 22, the power management device 100 may switch from the second mode to the third mode. When the output current of the first battery 20 is less than the output current of the second battery 3, the SOC of the second battery 30 is greater than the second reference value, and the temperature of the second battery 30 is within the predetermined temperature range, the power management device 100 may switch from the second mode to the third mode.

The power management device 100 may control the power transmission device 40 to turn on the second power switch 44 to switch to the third mode.

The first power switch 43 may include the first freewheeling diode 45 that allows a current from the second power network PN2 to the first power network PN1 and blocks a current from the first power network PN1 to the second power network PN2. In addition, the second power switch 44 may include the second freewheeling diode 46 that allows the current from the first power network PN1 to the second power network PN2 and blocks the current from the second power network PN2 to the first power network PN1.

In other words, the power management device 100 may maintain the off state of the first power switch 43 including the first freewheeling diode 45 and turn on the second power switch 44 including the second freewheeling diode 46.

Thereafter, the power management device 100 may turn off the cut-off switch 23 (1060).

The power management device 100 may turn off the cut-off switch 23 in order to switch to the fourth mode through the third mode. Since the cut-off switch 23 is turned off, the first electrical load 22 may receive the power from the second battery 30.

Thereafter, the power management device 100 may turn on the first power switch 43 (1070).

The power management device 100 may turn on the first power switch 43 to complete the conversion to the fourth mode.

Since the cut-off switch 23 is turned off and the first and second power switches 43 and 44 are turned on, the first electrical load 22 may receive the power from the second battery 30.

Through the above operation, a power supply source of the first electrical load 22 may be changed from the first battery 20 to the second battery 30 without a risk that the first electrical load 22 is reset.

According to the embodiments of the present disclosure, it is possible to provide the vehicle including the vehicle power converter capable of preventing power interruption or overcurrent during power redistribution.

Embodiments of the present disclosure have been described above. In the embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said and in addition to the above described embodiments, embodiments can thus be implemented through computer readable code/instructions in/on a medium, e.g., a computer readable medium, to control at least one processing element to implement any above described embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While the inventive concept has been described with respect to a limited number of embodiments, those having ordinary skill in the art, having the benefit of the present disclosure, should appreciate that other embodiments can be devised, which do not depart from the scope as disclosed herein. Accordingly, the scope should be limited only by the attached claims.

What is claimed is:

1. A vehicle comprising:
a first battery;
a first electrical load;
a second battery;
a cut-off switch provided between the first battery and the first electrical load;
a power transmission device provided between the first electrical load and the second battery, wherein the power transmission device includes a first power switch and a second power switch connected back-to-back to each other and a DC-DC converter connected in parallel with the first and second power switches; and
a power management device configured to control the power transmission device and the cut-off switch,
wherein, based on the vehicle being turned off, the power management device is configured to turn off the cut-off switch and turn on at least one of the first and second power switches.

2. The vehicle according to claim 1, wherein, based on the vehicle being turned on, the power management device is configured to turn on the cut-off switch, to turn off the first and second power switches, and to operate the DC-DC converter.

3. The vehicle according to claim 2, wherein, based on the vehicle being turned off, the power management device is configured to turn off the DC-DC converter.

4. The vehicle according to claim 3, wherein, based on a charging state of the first battery and a charging state of the second battery, the power management device is configured to turn on the at least one of the first and second power switches.

5. The vehicle according to claim 3, wherein, based on an output current of the first battery being less than an output current of the second battery, the power management device is configured to turn on the at least one of the first and second power switches.

6. The vehicle according to claim 3, wherein, based on a state of charge (SOC) of the second battery being greater than a reference value, the power management device is configured to turn on the at least one of the first and second power switches.

7. The vehicle according to claim 3, wherein:
the first power switch comprises a first freewheeling diode that allows a current from the second battery to the first electrical load and blocks a current from the first battery to the second battery; and
based on a charging state of the first battery and a charging state of the second battery, the power management device is configured to turn on the first power switch among the first and second power switches.

8. The vehicle according to claim 3, wherein the power management device is configured to turn off the cut-off switch after turning on the at least one of the first and second power switches.

9. The vehicle according to claim 8, wherein the power management device is configured to turn on both the first and second power switches after turning off the cut-off switch.

10. The vehicle according to claim 9, wherein, after turning on both the first and second power switches, the power management device is configured to turn on the cut-off switch and turn off both the first and second power switches based on a charging state of the first battery and a charging state of the second battery.

11. The vehicle according to claim 9, wherein, after turning on both the first and second power switches, the power management device is configured to turn on the cut-off switch and turn off both the first and second power switches based on an output current of the first battery being greater than an output current of the second battery or a state of charge (SOC) of the second battery being less than a reference value.

12. A method of controlling a vehicle, the vehicle including a first battery, a first electrical load, and a second battery, the method comprising:
based on the vehicle being turned on, turning on, by a power management device, a cut-off switch provided between the first battery and the first electrical load and operating a DC-DC converter provided between the first electrical load and the second battery;
based on the vehicle being turned off, turning off, by the power management device, the DC-DC converter; and
based on the vehicle being turned off, turning on, by the power management device, at least one of first and second power switches provided between the first electrical load and the second battery and connected back-to-back to each other.

13. The method according to claim 12, wherein the turning on the at least one of the first and second power switches comprises:
based on a charging state of the first battery and a charging state of the second battery, turning on the at least one of the first and second power switches.

14. The method according to claim 12, wherein the turning on the at least one of the first and second power switches comprises:
based on an output current of the first battery being less than an output current of the second battery, turning on the at least one of the first and second power switches.

15. The method according to claim 12, wherein the turning on the at least one of the first and second power switches comprises:
based on a state of charge (SOC) of the second battery being greater than a reference value, turning on the at least one of the first and second power switches.

16. The method according to claim 12, wherein the turning on the at least one of the first and second power switches comprises:
based on a charging state of the first battery and a charging state of the second battery, turning on the first power switch including a first freewheeling diode that allows a current from the second battery to the first electrical load and blocks a current from the first battery to the second battery.

17. The method according to claim 12, further comprising:
turning off, by the power management device, the cut-off switch after turning on the at least one of the first and second power switches.

18. The method according to claim 17, further comprising:
turning on, by the power management device, both the first and second power switches after turning off the cut-off switch.

19. The method according to claim 18, further comprising:
after turning on both the first and second power switches, turning on, by the power management device, the cut-off switch and turn off both the first and second power switches based on a charging state of the first battery and a charging state of the second battery.

20. The method according to claim 18, further comprising:
after turning on both the first and second power switches, turning on, by the power management device, the cut-off switch and turning off both the first and second power switches based on an output current of the first battery being greater than an output current of the second battery, a state of charge (SOC) of the first battery being less than a first reference value, or the SOC of the second battery being less than a second reference value.
